(19) United States
(12) Patent Application Publication
(10) Pub. No.: US 2013/0271293 A1
(43) Pub. Date: Oct. 17, 2013

(54) WARNING SYSTEM WITH WARNING SIGNALER OF A VEHICLE AND A METHOD FOR WARNING OCCUPANTS OF A VEHICLE

(71) Applicant: GM GLOBAL TECHNOLOGY OPERATIONS LLC, Detroit, MI (US)

(72) Inventors: Christian Rudolf JERUSALEM, Ruesselsheim (DE); Johannes HUTH, Frankfurt (DE); Gerald SCHMIDT, Frankfurt am Main (DE)

(73) Assignee: GM GLOBAL TECHNOLOGY OPERATIONS LLC, Detroit, MI (US)

(21) Appl. No.: 13/782,696

(22) Filed: Mar. 1, 2013

(30) Foreign Application Priority Data
Apr. 11, 2012 (DE) 10 2012 007 388.7

(51) Int. Cl. B60Q 9/00

(52) U.S. Cl. CPC B60Q 9/00
USPC 340/905

(57) ABSTRACT

A warning system of a vehicle is provided. The warning system includes a haptic warning signaler, a control module, and a haptic sensor. The haptic warning signaler is associated with the haptic sensor for recording a haptic receptiveness. For a traffic or operating situation of the vehicle ranked as critical, the control module activates the haptic warning signaler if the haptic sensor signals a haptic receptiveness to the control module. A method for warning occupants of a vehicle also is provided.

### CROSS-REFERENCE TO RELATED APPLICATION

This application claims priority to German Patent Application No. 10 2012 007 388.7, filed Apr. 11, 2012, which is incorporated herein by reference in its entirety.

1. Technical Field

The technical field relates to a warning system with a haptic warning signaler and a control module of a vehicle, and a method for warning occupants of a vehicle.

2. Background

The document DE 10 2006 056 444 A1 discloses a method and a device for warning a driver of a vehicle when exceeding the momentarily admissible maximum speed. The vehicle comprises a traffic sign recognition device. The momentarily admissible maximum speed for the vehicle is recognized and compared with a momentary speed of the vehicle. If the momentarily admissible maximum speed is exceeded, a warning signal is communicated to the driver by the traffic sign recognition device. In order to warn a driver of the vehicle that the momentarily admissible maximum speed of the vehicle has been exceeded, at least two signalers are provided, which are configured to issue a warning signal to the driver when the momentarily admissible maximum speed is exceeded, wherein a first one of the signalers is configured to issue a warning signal of a first warning signal type and a second one of the signalers is configured to issue a second warning signal different from the first one. The driver is warned against traffic dangers by different warning signal types or a combination of the different warning signal types.

It is desirable herein to provide a warning system with a haptic warning signaler of a vehicle and a method for warning occupants of a vehicle, which ascertains as to whether haptic warnings can be detected by at least a driver. In addition, other objects, desirable features and characteristics will become apparent from the subsequent summary and detailed description, and the appended claims, taken in conjunction with the accompanying drawings and this background.

### SUMMARY

In one embodiment, a warning system with a haptic warning signaler and a control module is provided. The a haptic warning signaler is associated with a sensor for recording a haptic receptiveness. For a traffic or operating situation of the vehicle, which is ranked as critical, the haptic warning signaler can be activated by the control module, if the associated sensor signals the haptic receptiveness to the control module.

Several of the functional units described in the following specification have been called modules in order to particularly emphasize that they are independent from the implementation. Modules will include hardware circuits with one or more processors with memory, maximum integration circuits (VSLI), gate arrays, programmable logic and/or discrete components. The hardware circuits may execute logic functions, execute computer-readable programs stored on tangible storage devices and/or execute programmed functions. Modules may also include a computer-readable storage medium comprising a computer-readable program, which is stored on a tangible storage device, which performs a function if executed by a hardware circuit such as a processor, microprocessor or the like.

Haptic warning signalers, in contrast to acoustic or optical warning signalers, have the advantage that they can warn individually, which makes the warning confidential and only warns the respectively concerned occupant of the vehicle against dangers to safety, thereby ensuring better acceptance, when used frequently, by the driver and the other occupants of the vehicle. Haptic warning signalers, however, are useful only if they are haptically in contact with the respective vehicle occupant at the time of the warning, i.e. when there exists receptiveness on the part of the vehicle occupant to be warned.

Haptic warning signalers are, however, useless if they are not touched at the moment of the warning being signaled. Besides, decisive time spans may pass unused until a different kind of warning signal is triggered, if the person to be warned does not check the receptiveness, and haptic warning signalers are needlessly activated. Therefore it is a decisive advantage that the new warning system provides for at least one sensor to be associated with a haptic warning signaler. It is thus possible for the control module to automatically activate another warning stage and to skip the warning stage of a haptic warning signaler if the sensor signals that there is no receptiveness for the haptic warning signal. In a further embodiment therefore a contact sensor may be integrated with the haptic warning signaler and be in communication with the control module. For this purpose the control module may comprise a contact detecting module which interacts with the integrated contact sensor of the haptic warning signaler.

A further advantage of the warning system consists in that a collective warning of all occupants does not initially take place via an acoustic warning signaler if a critical traffic or operating situation of the vehicle occurs, thus avoiding alerting the passengers unnecessarily. For example, the driver may be individually warned successfully and reliably by the haptic warning signaler of a critically ranked traffic or operating situation, without frightening the passengers of the vehicle, if the associated sensor has signaled the haptic receptiveness of the driver to the control module.

In an embodiment, the receptiveness of a haptic warning signal may be reported by associated sensors which are implemented as contactless proximity switches such as capacitive or inductive sensors in the steering wheel or in the pedals or in the gear lever. In addition it is possible to check the receptiveness via mechanical switches in different final control elements of the vehicle. Or signals of a camera monitoring the passenger compartment of the vehicle may signal a receptiveness for haptic warning signals. Another possibility would be to evaluate signals of a steering angle sensor or signals of brake pedal, accelerator travel or clutch travel transmitters for recording the receptiveness. If, however, a driver assistance system is active, for example a cruise control system, a lateral assistance system or another such system, in an embodiment, the respective final control element of the vehicle controlled by the respective driver assistance system is no longer used for haptic warnings.

In another embodiment, a haptic warning signaler in each seat individually warns passengers that his/her safety belt has not been fitted, if associated sensors signal to the control module that the vehicle seat is occupied, but the safety belt of this occupied seat has not been applied. Further haptic warning signalers may be arranged in the vicinity of the driver, for example haptic warning signalers on the steering column or on the steering wheel or on the foot pedals such as on an accelerator pedal. However, these are only useful if the driver or a respective passenger is haptically receptive.

The warning system thus focuses not only on the driver but also on the passengers of the vehicle who can contribute to the vehicle's operational safety and traffic safety, in that it, for example, ensures that all occupants have applied their safety belts, and if this is not the case, issues a corresponding stepped warning signal to the respective occupant of the vehicle. Moreover, the known warning system is focused on the recognition and recording of traffic signs, in particular speeds limits, in order to communicate a warning signal initially to the driver individually.

In a further embodiment, the control module automatically activates another warning signaler, if there is no receptiveness for the at least one haptic warning signaler or if, despite the signaled receptiveness from the control module, no measure can be ascertained for avoiding the traffic or operating situation ranked as critical. Conversely, this means that advantageously no further warning stage is activated if upon detecting the haptic warning signaler, the driving or operating state of the vehicle is corrected. Also there is no need for issuing a nerve-shattering acoustic warning if following the detection of a haptic warning signaler the driving or operating state of the vehicle is immediately changed. For automatic control of the warning signal stages the control module may comprise a decision signaling module which interacts with the warning signalers.

Finally provision is made in a further embodiment for the control module to comprise a decision signaling module, which interacts with several different warning signalers, wherein the control module is configured, starting from a lower warning stage, to automatically activate a next higher warning stage, if no measure for avoiding the critically ranked traffic or operating situation can be ascertained.

To this end, in an embodiment, the warning system further comprises an optical warning signaler and an acoustic warning signaler. For a traffic or operating situation of the vehicle ranked as critical, the warning signalers are stepped, with the optical warning signaler as the first warning stage, the haptic warning signaler as the second warning stage, the acoustic warning signaler as the third warning stage and all warning signalers together as the highest warning stage, so that they can be simultaneously activated by the control module.

A further embodiment relates to a motor vehicle, which comprises a warning system with the haptic warning signaler as defined above. In addition the vehicle, in a further embodiment, includes an environment sensor which is in communication with the control module of the warning system. Such environment sensors may be cameras, ultrasound radars or other LIDAR devices. Also, the vehicle may comprise vehicle interior monitoring sensors which are operatively connected with the control module and which, for example, ascertain fatigue symptoms by recording the driver's eyelid movements and alert the driver via a haptic warning signaler in the driver's seat, similarly to the haptic warning signalers in the vehicle seats which signal that the safety belt has not been applied. Finally the control module may comprise a danger detecting module which interacts with the environment sensors of the motor vehicle in order draw attention in good time to critical traffic situations outside the vehicle.

In an exemplary embodiment, a method for warning occupants of a vehicle comprising a haptic warning signaler and a control module may comprise the following method steps. To begin with, traffic or operating situations are ranked as critical. Then it is checked whether a signal of haptic receptiveness was received in the control module which was sent by a sensor associated with the haptic warning signaler. If yes, the haptic warning signaler is activated, and if no, a warning signaler of a different kind is activated. If no measure is taken to avoid the critical traffic or operating situation of the vehicle, a driver assistance system may be initiated to automatically take over.

In an embodiment, if a measure is taken to avoid the traffic or operating situation ranked as critical, the respective warning is terminated. Furthermore provision is made in the warning method that in addition to or as to alternative to the haptic warning signaler an optical or an acoustic warning signaler is activated. Finally it is also possible for the optical, the haptic and the acoustic warning signaler to be activated simultaneously in a traffic or operating situation ranked as most dangerous.

In another embodiment of the method for warning occupants of a vehicle by an optical, a haptic or an acoustic warning signaler, the following method steps may be executed in a staggered or a stepped fashion. To begin with, a traffic or operating situation of the vehicle is ranked as critical. Then an optical warning signaler may be activated as the first warning stage. If this warning has no effect, the haptic warning signaler may be activated as the second stage, provided an associated sensor is haptically receptive. If there is no receptiveness or if despite receptiveness no measure is taken for avoiding the traffic or operating situation ranked as critical, activation of the acoustic warning signaler as the highest warning stage is initiated by the control module.

This method has the advantage that for a traffic or operating situation ranked as critical, activation of the warning signalers begins with the lowest warning stage and ends with the highest warning stage. The warning may be terminated in each of the warning stages in case a measure is taken for avoiding the traffic or operating situation ranked as critical.

In an embodiment, if the traffic or operating situation of the vehicle is ranked, not only as critical, but as dangerous, both the optical and the haptic signalers are immediately activated. If the traffic or operating situation is ranked as most dangerous by the danger detecting module, all three warning stages are simultaneously activated. These method variants have the advantage that the various steps of a traffic and operating situation, such as a critical, dangerous or most dangerous situation, can also be automatically recorded by the danger detecting module in the control module.

With a method for passenger compartment monitoring it is particularly advantageous, in cases where safety belts of vehicle seats have not snapped in, to alert the respective passenger by vibrating the seat surface, i.e. by alerting him by a haptic warning signal without immediately issuing a piercing acoustic warning signal which would be perceived as extremely disruptive. In addition, in contrast to the warnings of critical, dangerous or most dangerous traffic situations, provision may be made in an advantageous manner for a delay time, whereby a suitable time span for fastening the safety belt is taken into account, before the highest warning stage is activated by the control module in the form of an acoustic signal.

### BRIEF DESCRIPTION OF THE DRAWINGS

The various embodiments will hereinafter be described in conjunction with the following drawing figures, wherein like numerals denote like elements, and wherein:

FIG. 1 shows a block diagram of a warning system according to an embodiment;

FIG. 2 shows a flow diagram of a method for warning occupants of a vehicle in accordance with an exemplary embodiment;

FIG. 3 shows a flow diagram of for warning occupants of a vehicle in accordance with another exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

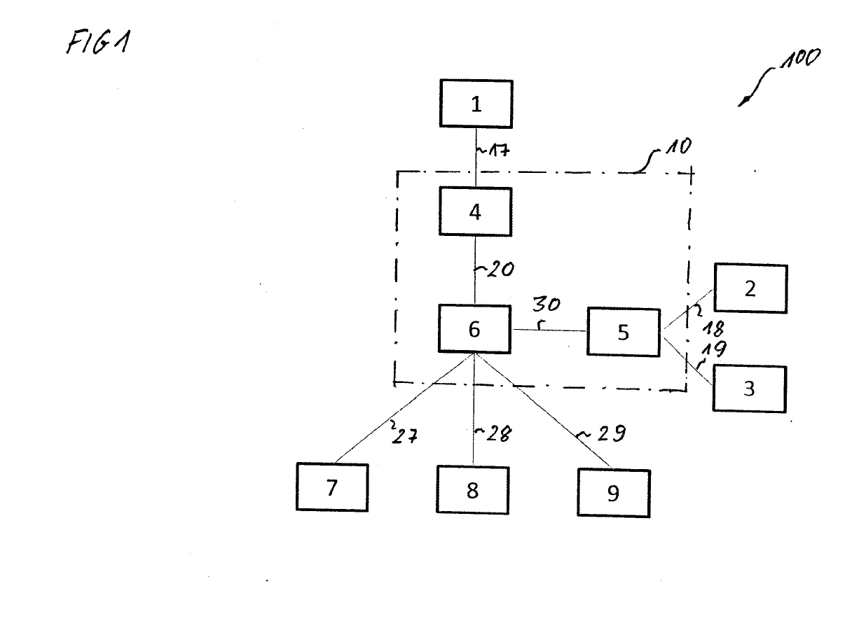

FIG. 1 shows a block diagram of a warning system 100 according to an exemplary embodiment. The warning system 100 comprises a control module 10 which at least comprises three modules 4, 5 and 6, wherein module 4 is a danger detecting module, module 5 is a contact detection module and module 6 is a decision signaling module. In addition the warning system 100 comprises at least three sensor types. The reference symbol 1 marks environment sensors which interact via signal lines 17 with the control module 10.

The environment sensors 1 may comprise cameras with picture evaluation, which monitor a traffic and driving situation by detecting traffic signs. Environment sensors may also include distance radar sensors which record the distances to vehicles driving in front. Further the environment sensors may include carriageway marking sensors, with which markings delineating the carriageway may be detected and recorded. These sensor signals are fed to the danger detecting module 4 via the signal line 17 wherein danger detecting module 4 then evaluates and compares the signals.

The reference symbol 2 is used to mark contact sensors which, in an embodiment, interact with the contact detecting module 5 via a signal line 18, wherein these contact sensors 2 may comprise capacitive elements in the contact surfaces of haptic warning signalers. Via a further signal line 19 passenger compartment sensors 3 communicate with the contact detecting module 5 of control module 10. Signals of the contact detecting module 5 are directed via a connecting line 30 within the control module 10 to a decision signaling module 6 within the control module 10, and signals of the danger detecting module 4 are directed via a signal connection 20 to the decision signaling module 6, which evaluates these signals and automatically activates, in steps, warning signalers 7, 8 or 9 via alarm lines 27, 28 and 29. An optical warning signaler 7 is activated in a lowest warning stage via the alarm line 27, and a next higher warning stage is activated by a haptic warning signaler 9 via the alarm line 29, and finally an acoustic warning signaler is activated as the highest warning stage via the alarm line 28.

In an embodiment, the haptic warning signaler 9, however, can only be activated on condition that a positive signal of the contact sensor 2 was fed to the contact detecting module 5 via the signal line 18, which in turn signals to the decision signaling module 6 via the signal connection 30 that the haptic warning signaler 9 has been touched, as otherwise the highest alarm stage for activating the acoustic warning signaler 8 via the alarm line 28 would be triggered by the decision signaling module 6.

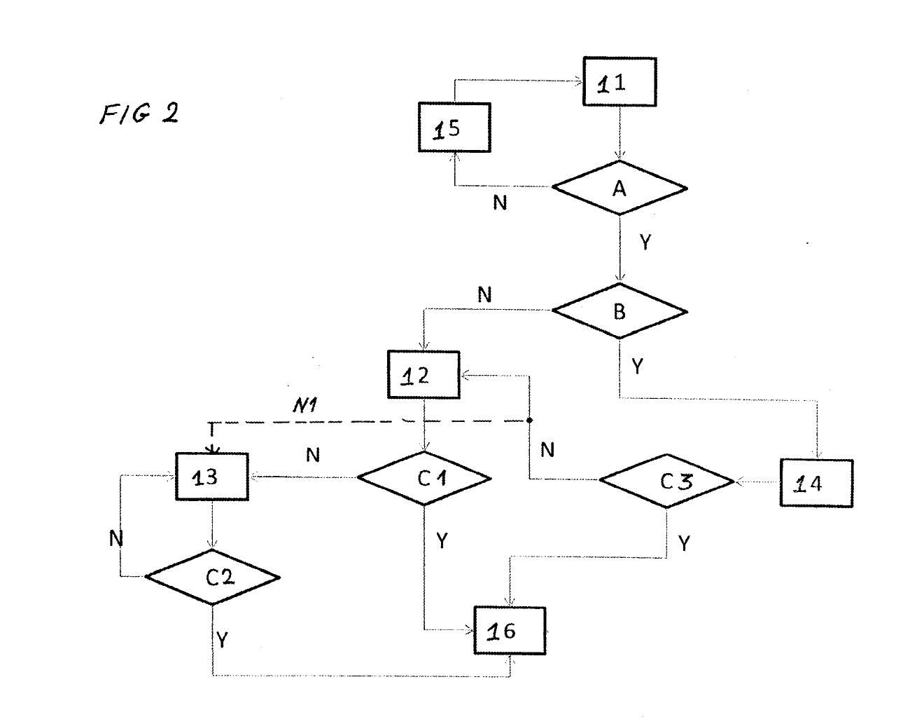

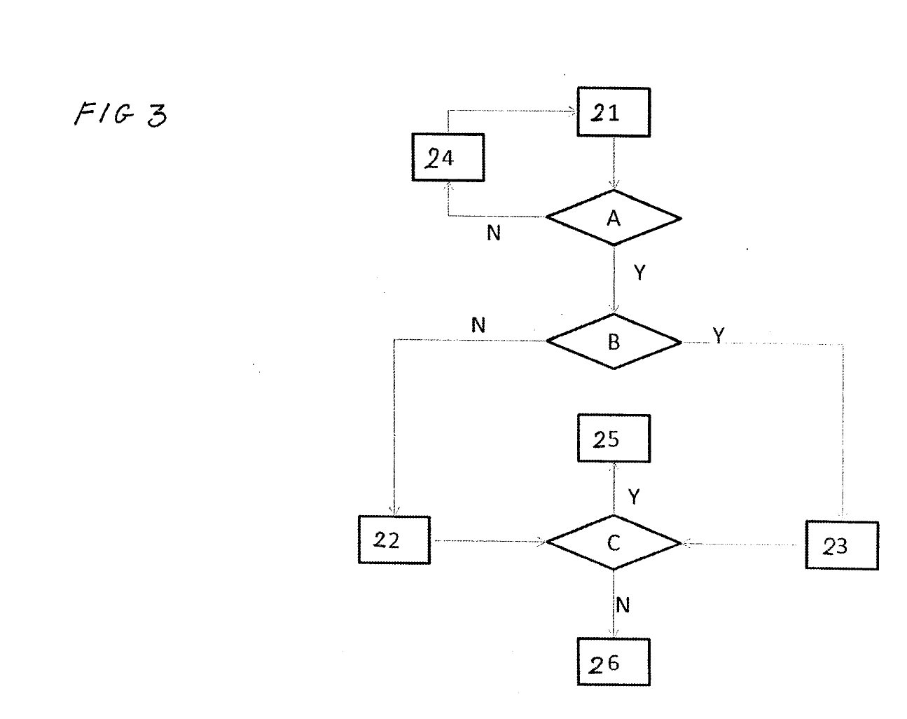

The subsequent flow diagrams of FIGS. 2 and 3 are used to describe in detail a method for warning occupants. FIG. 2 shows a flow diagram of a first exemplary implementation of the method with six method steps 11-16 and three different polling steps A, B and C with C1, C2 and C3. The method starts with the method step 11 and checks using a first polling step A, whether a driver or occupant warning is required. If this is not the case, there being no critical traffic or operating situation, method step 15 does not trigger a warning and the system returns to the first method step 11, i.e. to the start.

If a driver or occupant warning is required, a second polling step B then queries whether the driver or the occupants are touching a haptic unit. If this is not the case, as marked by N, an optic warning is triggered in method step 12, and it is checked in a third polling step C1, whether the driver or the occupants respond to the optical warning. If this is the case, as marked by Y, the automatic warning is switched off in method step 16.

If, however, there is no response to the optical warning, as marked with N, an acoustic warning is triggered in method step 13, which leads to a third polling step C2, where it is checked again, whether the driver or occupants are responding to the warning. If this is not the case, the acoustic warning step 13 continues, and if this is the case, as marked with Y, the automatic warning is terminated in method step 16.

In the second polling step B, as explained above, it is checked whether a haptic unit is touched by the driver or the occupants. If the touch is confirmed by the respective contact sensor, a haptic warning is triggered in method step 14 which leads to a third polling step C3, where it is checked again, whether the driver or the occupants are responding to the haptic warning. If this is not the case, as marked with N, the optical warning is triggered in method step 12, which, if neither the driver nor the occupants respond, can lead via polling step C1 to the acoustic warning in method step 13.

If, however, it is ascertained in polling step C3 that a response by the driver or the occupants took place based on the haptic warning in step 14, the automatic warning method is terminated in method step 16. An alternative solution is shown by a broken line N1 in the flow diagram in FIG. 2, where, if there is no response to the haptic warning in step 14, the highest warning stage is immediately triggered in method step 13, i.e. an acoustic warning.

FIG. 3 shows a flow diagram of another exemplary embodiment of the method. This method starts with method step 21 and a query is made in polling step A whether a warning of the driver or the occupants is required. If this is not the case, as marked with the letter N, step 24 signifies that no warning is triggered and the entire method begins again with starting step 21. If it is ascertained in polling step A that a warning to the driver or occupants is required, as marked with letter Y, a further polling step B immediately follows in which it is queried and checked whether the driver or the occupants are touching a haptic unit.

If this is not the case, method step 22 follows which simultaneously triggers an optical and an acoustic warning signal, and then it is checked in polling step C, whether the driver or occupants are responding. If this is not the case, an alternative action is triggered in method step 26, for example by an autonomous driver assistance system. If, however, following polling step C, a response to the warning is detected, the automatic warning is terminated in method 25.

If, however, it is ascertained in polling step B that the driver or occupants touch the haptic unit, as marked with Y, method step 23 follows, where an optical and a haptic warning are triggered simultaneously and polling step C is performed again, in which it is checked whether the driver or occupants respond to the warning so that if there is a response to the warning, method step 25 is performed with termination of the automatic warning, and if there is no response, alternative actions are triggered in method step 26, in which, for example, as already mentioned an autonomous take-over of a driver assistance system is activated.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A warning system of a vehicle, the warning system comprising:
a haptic warning signaler;
a control module, and
a haptic sensor,
wherein the haptic warning signaler is associated with the haptic sensor for recording a haptic receptiveness, and wherein for a traffic or operating situation of the vehicle ranked as critical, the control module activates the haptic warning signaler if the haptic sensor signals a haptic receptiveness to the control module.

2. The warning system according to claim 1, wherein the control module automatically activates a warning signaler other than a haptic warning signaler if there is no haptic receptiveness or if despite a signaled haptic receptiveness no measure for avoiding a traffic or operating situation ranked as critical is ascertained by the control module.

3. The warning system according to claim 1, wherein a contact sensor is integrated with the haptic warning signaler which is operatively connected with the control module.

4. The warning system according to claim 3, wherein the control module comprises a contact detecting module that interacts with the contact sensor of the haptic warning signaler.

5. The warning system according to claim 1, wherein the control module comprises a decision signaling module that interacts with several warning signalers.

6. The warning system according to claim 1, wherein the control module stepwise and automatically activates, starting at a lower warning stage, a next higher warning stage in case no measure for avoiding the traffic or operating situation ranked as critical is ascertained.

7. The warning system according to claim 1, wherein the warning system further comprises an optical warning signaler and an acoustic warning signaler, and wherein for a traffic or operating situation of the vehicle ranked as critical, the haptic, optical and acoustic warning signalers are activated in stages with the optical warning signaler as the first warning stage, the haptic warning signaler as the second warning stage, the acoustic warning signaler as the third warning stage and all warning signalers simultaneously as the highest warning stage, by the control module.

8. A motor vehicle comprising:
a warning system comprising:
a haptic warning signaler;
a control module, and
a haptic sensor,
wherein the haptic warning signaler is associated with the haptic sensor for recording a haptic receptiveness, and wherein for a traffic or operating situation of the vehicle ranked as critical, the control module activates the haptic warning signaler if the haptic sensor signals a haptic receptiveness to the control module, and
an environment sensor that is operatively connected with the control module of the warning system.

9. The motor vehicle according to claim 8, wherein the motor vehicle further comprises a passenger compartment monitoring sensor that is operatively connected with the control module.

10. The motor vehicle according to claim 8, wherein the control module comprises a danger detecting module which interacts with the environment sensor of the motor vehicle.

11. A method for warning occupants of a vehicle which comprises a haptic warning signaler and a control module, wherein the method comprises the steps of:
ranking a traffic or operating situation of the vehicle as critical;
checking whether a signal of a haptic receptiveness of the vehicle is signaled to the control module by a sensor associated with the haptic warning signaler;
if yes, activating the haptic warning signaler;
if no, activating a further warning signaler;
if no measure for avoiding the critical traffic or operating situation of the vehicle is taken, activating a driver assistance system.

12. The method according to claim 11, wherein activating the respective warning signaler is terminated if a measure for avoiding the traffic or operating situation ranked as critical is taken.

13. The method according to claim 11, wherein additionally or alternatively to the haptic warning signaler an optical or an acoustic warning signaler is activated.

14. The method according to claim 13, wherein in a traffic or operating situation ranked as most dangerous the optical, the haptic and the acoustic warning signaler are simultaneously activated.

15. A method for warning occupants of a vehicle by an optical, a haptic or an acoustic warning signaler, wherein the method comprises the steps of:
ranking a traffic or operating situation as critical;
activating the optical warning signaler as a first warning stage,
activating the haptic warning signaler as the second warning state in case no measure for avoiding the traffic or operating situation ranked as critical is taken;
activating the acoustic warning signaler as the third warning stage in case it is detected that the haptic warning signaler is not touched or, despite touching, no measure for avoiding the traffic or operating situation ranked as critical is taken;
activating all three warning signalers together as the highest warning stage, and
activating an automatic driver assistance system in case of extreme danger.
